(19) United States
(12) Patent Application Publication
(10) Pub. No.: US 2018/0107996 A1
(43) Pub. Date: Apr. 19, 2018

(54) Methods and Systems for Scheduling Payments

(71) Applicant: MASTERCARD INTERNATIONAL INCORPORATED, Purchase, NY (US)

(72) Inventors: Ravi Pareek, Pune (IN); Arunmurthy Gurunathan, Pune (IN)

(21) Appl. No.: 15/782,499

(22) Filed: Oct. 12, 2017

(30) Foreign Application Priority Data
Oct. 14, 2016 (SG) 10201608645X

(51) Int. Cl. G06Q 20/10; G06Q 40/02; G06Q 30/04; H04W 4/14; H04M 1/725

(52) U.S. Cl. CPC G06Q 20/102; G06Q 40/02; H04M 1/72563; H04W 4/14; G06Q 30/04

(57) ABSTRACT

A method and system are presented for scheduling payments. The method comprises the operations of: a) storing, in a memory, instructions for an action to be taken when at least one specified criterion is fulfilled, the specified criterion relating to anticipated funds to be received and/or anticipated funds authorized for receipt; b) receiving, by a processor, details of funds received and/or funds authorized for receipt; c) checking, by the processor, whether the specified criterion is fulfilled; d) repeating steps b) and c) until the specified criterion is fulfilled; and e) upon fulfillment of the specified criterion, actioning the instructions stored in the memory.

### CROSS-REFERENCE TO RELATED APPLICATION

This application claims the benefit of and priority to Singapore Patent Application No. 10201608645X filed Oct. 14, 2016. The entire disclosure of the above application is incorporated herein by reference.

### FIELD

The present disclosure relates to methods and systems for scheduling payments. In particular, the disclosure relates to the advanced scheduling of payments from bank accounts.

### BACKGROUND

This section provides background information related to the present disclosure which is not necessarily prior art.

It is often desirable, if not necessary, to wait for anticipated income, such as a salary, to be received in a bank account before money is paid out for bills, and the like. However, the actual date of receipt of income may not be known in advance due to delays in the transfer of funds from one account to another and the delay caused by non-working days. Thus, although it is possible to set up a payment for a specified future date, it is difficult for users to be certain of the date when income will actually be received and available for the payment in advance of receipt.

Merchants also face a delay in receipt of funds after a cashless transaction has been authorized (e.g., via a payment card or electronic wallet). Accordingly, merchants often need to wait for a few days between the sale of goods or services and actual receipt of the payment. This delay can impact the merchant's ability to pay suppliers for further stock, for example, and is therefore undesirable.

Consequently, there is a need for improved methods and systems for scheduling payments.

### SUMMARY

This section provides a general summary of the disclosure, and is not a comprehensive disclosure of its full scope or all of its features. Aspects and embodiments of the disclosure are set out in the accompanying claims.

In accordance with a first aspect of the present disclosure there is provided a computerized method for scheduling payments comprising:
a) storing in a memory instructions for an action to be taken when at least one specified criterion is fulfilled, the specified criterion relating to anticipated funds to be received and/or anticipated funds authorized for receipt;
b) receiving, by a processor, details of funds received and/or funds authorized for receipt;
c) checking, by the processor, whether the specified criterion is fulfilled;
d) repeating steps b) and c) until the specified criterion is fulfilled; and
e) upon fulfillment of the specified criterion, actioning the instructions stored in the memory.

The instructions may relate to a scheduled payment to be made when the specified criterion is fulfilled, such that, upon fulfilment, the payment is initiated.

Alternatively, the instructions may relate to providing a notification to a user (i.e. recipient) of the funds received and/or funds authorized for receipt such that the user can choose whether to make a payment as soon as the funds/authorization is received.

Embodiments of the disclosure therefore provide a method that can be used to schedule payments more efficiently for better fund management. In particular, action is only taken when specified funds have been received or authorized and therefore there is more certainty that the funds will be available for a payment than in the case of a known date-specific payment.

Advantageously, embodiments of the disclosure can be employed by individuals to better manage regular incoming and outgoing funds ensuring that there is little to no delay from the funds being received to payment being made whilst also ensuring that payment is only initiated after the required funds have been received (thereby avoiding any penalties which may be incurred if the account is overdrawn). Scheduled payments can be made when the individual is not available to check the account and/or instruct payment themselves (e.g., when he/she is on holiday or simply offline). In addition, there is less risk of the received funds being inadvertently spent on other things as the scheduled payment can be initiated as soon as the funds become available, thereby minimizing the time that the funds are actually in the account.

Embodiments of the disclosure also allow merchants to make payments against authorized transactions such that payments can be made even before the merchant is in receipt of the authorized funds. Normally funds appear in an account 2 to 3 business days after authorization of a cashless transaction. However, since the transaction has been authorized, the acquirer bank can be certain that the merchant is entitled to receive the funds. Accordingly, an acquirer bank may agree to make some or all of the authorized funds available to the merchant before the money is actually received in the merchant's account. In effect, the acquirer bank may agree to loan the merchant some or all of the authorized funds in the knowledge that the loan will be re-paid when the funds are received. It will be understood that the term ‘authorized funds’ is used throughout to mean funds that are authorized but not yet received.

The specified criterion may comprise one of more of a name, entity, account number, amount, date or predetermined type of payment (e.g., salary, rental income or pension income). The amount may comprise an individual amount received or authorized; an accumulated amount received or authorized; or a portion of an amount received or authorized. The specified criterion may comprise a specified amount (e.g. a deposit of X amount) or an amount equal to or greater than a specified amount.

The instructions may comprise instructions for payment and may be for one time only payments or regular payments (e.g., monthly, quarterly or annually). The instructions may be used to schedule bill payments (e.g., rent or utilities) or to transfer funds to another account.

The instructions for payment could be conditional on the funds received. For example, instructions could be set to pay utility bills when rental income is received; to transfer funds to a loan or savings account on receipt of salary; to transfer funds to another person when receiving funds from a specific source; or to pay a mortgage when rent is received from tenants.

In the case of merchant authorizations, the instructions may comprise sending a notification when each authorization is received; when a specified accumulated amount of authorizations are received; or at a specified time or frequency (e.g., daily) to report the authorizations to date.

The method may be implemented on a user device, such as a mobile phone, personal computer, tablet, laptop, key-fob or personal digital assistant (PDA). The user device may be in communication with a host server which in turn may be in communication with an issuer bank. Alternatively, the user device may be in direct communication with the issuer bank.

The user device may be employed by the user to set-up the instructions (e.g., for the payment or notification to be made) and the specified criterion (e.g., amount). The instructions and criterion may then be communicated to the issuer bank (in the case of funds received) or payment card system (in the case of authorizations received) and an alert established to signal when the specified criterion has been fulfilled.

Upon fulfillment of the specified criterion, the issuer bank/payment card system may send the alert to the user device (e.g., via a mobile application, SMS, email etc.) for information and/or confirmation before initiating the payment according to the instructions.

Merchants may be permitted to spend the authorized funds only on pre-defined goods or services or with pre-defined parties (e.g., to pay suppliers, rent or utility bills). As such, merchants may be unable to withdraw the authorized funds as cash and instead may only be permitted to transfer the funds to a pre-defined receiver.

The acquirer bank may decide to loan some or all of the authorized funds to the merchant based on the amount of risk they are willing to take in case the transaction is cancelled and/or the funds never received. In some embodiments, up to 50%, 60%, 70%, 80%, 90% or 100% of the authorized funds may be made available to the merchant. In some embodiments, a fee may be charged by the acquirer bank for use of authorized funds. The fee may be deducted from the authorized funds.

The method may further comprise a set-up procedure wherein the user or merchant provides the instructions and the at least one specified criterion.

In accordance with a second aspect of the present disclosure there is provided a system comprising a processor for scheduling payments, the processor being configured to:
a) store in a memory instructions for an action to be taken when at least one specified criterion is fulfilled, the specified criterion relating to anticipated funds to be received and/or anticipated funds authorized for receipt;
b) receive details of funds received and/or funds authorized for receipt;
c) check whether the specified criterion is fulfilled;
d) repeat steps b) and c) until the specified criterion is fulfilled; and
e) upon fulfillment of the specified criterion, actioning the instructions stored in the memory.

The processor may be located in a user device, payment card server, host server or user's bank server (e.g., issuer bank server or acquirer bank server).

Notably, in the case of funds received, the user's bank server may monitor for the receipt of funds. However, in the case of authorizations, the payment card server may monitor for authorizations received and may notify the acquirer bank in the case that payment is to be made against any authorizations.

The processor may be configured to receive the instructions and/or specified criterion from a user application operating on a user device (e.g., mobile phone or computer). The user may be an individual or a merchant.

The processor may be configured to receive details of funds received and/or funds authorized for receipt from a user's bank server or payment card server.

Upon receipt of funds or authorized funds, the processor may communicate with the user application to inform the user of the receipt.

The user application may check whether the user intends to proceed with a payment when the specified criterion is met.

If the specified criterion is not met, the user application may communicate the same to the user.

In the case of authorized funds, the user application (or processor) may communicate to the user, the total authorized funds received and/or a predefined portion of the authorized funds received that is available for payments. The user application (or processor) may calculate an accumulated total of the predefined portions of multiple authorized funds and may generate an alert to the user when a target amount is reached.

The user may schedule a payment to be made when the target amount is reached, using the user application. The user application (or processor) may communicate the payment details to the user's bank server or payment card server (optionally, via a host server). The user's bank server may then initiate a payment and set a flag on the user account to deduct the portion of the authorized funds used for the payment from the total authorized funds when they are received in the user account. Accordingly, the payment is initiated before the funds have cleared in the user account and therefore the recipient of the funds receives the payment from the merchant earlier than if the merchant waited for the funds to clear first.

As used throughout this specification, the term payment card may comprise any suitable cashless payment mechanism, such as a credit card, a debit card, a prepaid card, a charge card, a membership card, a promotional card, a frequent flyer card, an identification card, a gift card, and/or any other physical or electronic device that may hold payment account information, such as digital wallets.

Embodiments of the disclosure may be expressed as a network of communicating devices (i.e., a “computerized network”). It may further be expressed in terms of a software application downloadable into a computer device to facilitate the method. The software application may be a computer program product, which may be stored on a non-transitory computer-readable medium on a tangible data-storage device (such as a storage device of a server, or one within a user device).

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the disclosure will now be described by way of example only with reference to the following drawings, in which:

FIG. 1 illustrates a method for scheduling payments in accordance with a first embodiment of the disclosure;

FIG. 2 illustrates a computerised network of electronic devices for performing the method of FIG. 1;

FIG. 3 shows a flow chart for a set-up procedure for scheduling a payment in accordance with an embodiment of the disclosure;

FIG. 4 shows a flow chart for initiation of a scheduled payment in accordance with an embodiment of the disclosure;

FIG. 5 shows a flow chart for a merchant to make a scheduled payment using authorized funds in accordance with an embodiment of the disclosure;

FIG. 6 shows a block diagram of the technical architecture of a server of FIG. 2; and

FIG. 7 shows a block diagram of a user device of FIG. 2.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

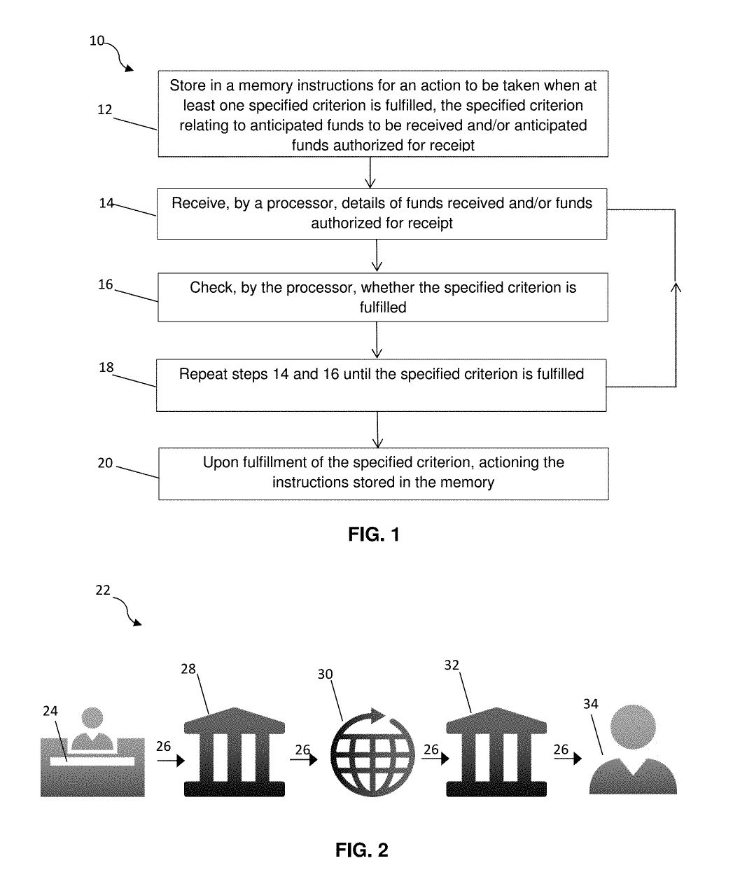

FIG. 1 shows a computerized method 10 for scheduling payments in accordance with a first embodiment of the disclosure. The method 10 comprises the following steps:
Step 12: storing, in a memory, instructions for an action to be taken when at least one specified criterion is fulfilled, the specified criterion relating to anticipated funds to be received and/or anticipated funds authorized for receipt;
Step 14: receiving, by a processor, details of funds received and/or funds authorized for receipt;
Step 16: checking, by the processor, whether the specified criterion is fulfilled;
Step 18: repeating steps 14 and 16 until the specified criterion is fulfilled; and
Step 20: upon fulfillment of the specified criterion, actioning the instructions stored in the memory.

FIG. 2 illustrates a computerized network or system 22 of electronic devices for performing the method of FIG. 1. Thus, the network 22 comprises a user device 24, connected via a communication network 26 to a user's bank server 28 which, in turn, is connected via the communication network 26 to a host server (or payment card server) 30 which, in turn, is connected via the communication network 26 to a receiver's bank server 32 and receiver device 34. It will be understood that when the user is a merchant wishing to schedule payments against authorized funds, the user's bank server 28 will be that of an acquirer bank. However, when the user is an individual or other entity wishing to schedule payments against funds received in their account, the user's bank server 28 will be that of an issuer bank.

Furthermore, the processor of FIG. 1 may be comprised in the host server 30 or the user device 24 or the user's bank server 28.

The user device 24 is associated with a person or entity who wishes to schedule a payment to a receiver associated with the receiver device 34 in accordance with embodiments of the present disclosure. The user device 24 and receiver device 34 may be constituted as smartphones, however they may each be constituted by any electronic communication device, such as a tablet computer, laptop, personal computer, or, in the case where the user is a merchant, a point-of-sale terminal.

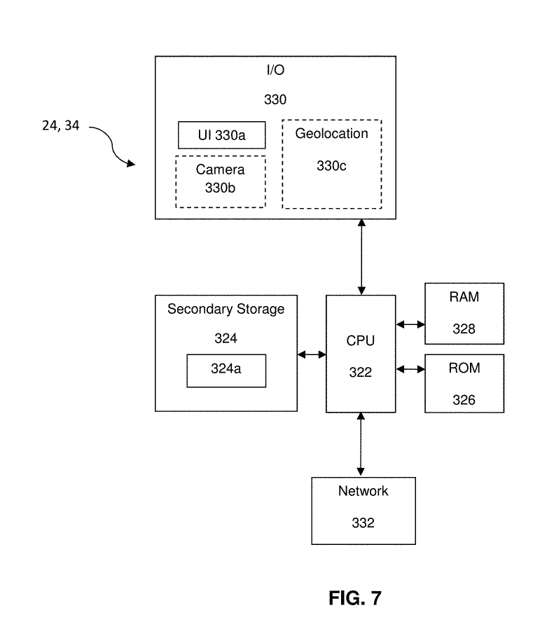

In general terms, both the user device 24 and the receiver device 34 can be considered to be communication devices (which are described below in more detail with reference to FIG. 7). They both may include screens and input devices. The screens may be touch sensitive, in which case separate input devices may not be required and the screens alone may provide a user interface for the communication device. Both the user device 24 and the receiver device 34 are able to communicate with the communication network 26 using respective communication interfaces (not shown). The communication devices 24, 34 may communicate with the communication network 26 via a wireless connection (e.g., GPRS, 3G, 4G, WIFI or Bluetooth™) or a wired connection.

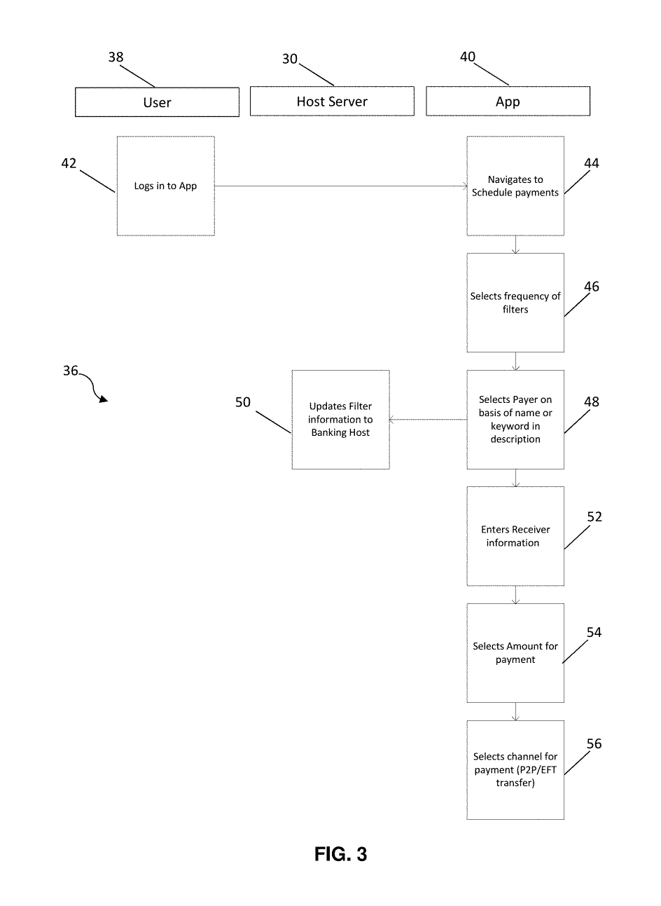

With reference to FIG. 3, there is illustrated a set-up procedure 36 for scheduling a payment in accordance with an embodiment of the disclosure. In this embodiment, the set-procedure 36 is mainly carried out by a user 38 (who may be an individual, entity or merchant) via a user application (App) 40 operating on the user device 24.

In a first step 42, the user 38 logs into the App 40 using previously established login details (e.g., username and password). The user 38 then navigates within the App 40 to a screen for scheduling payments in step 44. In step 46, the user 38 begins to enter specified criteria (i.e., filters) relating to anticipated funds to be received and, in this case, determines the frequency of the filters (i.e., how often the system will check whether the specified criteria is met). This may be hourly, daily, weekly or monthly. In step 48, the user enters details to identify the payer from whom the funds will be received. This may be done by providing the name of the person or entity or by providing keywords or reference codes to look for in a description field associated with the funds received. In step 50, the specified criteria (i.e., filter information) are communicated to the host server 30 for storing in a memory. In step 52, the user 38 enters into the App 40 the instructions for the payment to be made when the specified criteria is fulfilled. The instructions will identify the receiver and receiver account details. In step 54, the user 38 also stores the amount for the scheduled payment. In step 56, the user 38 optionally selects the channel for payment which may be a person-to-person (P2P) wallet transfer or an electronic fund transfer (EFT).

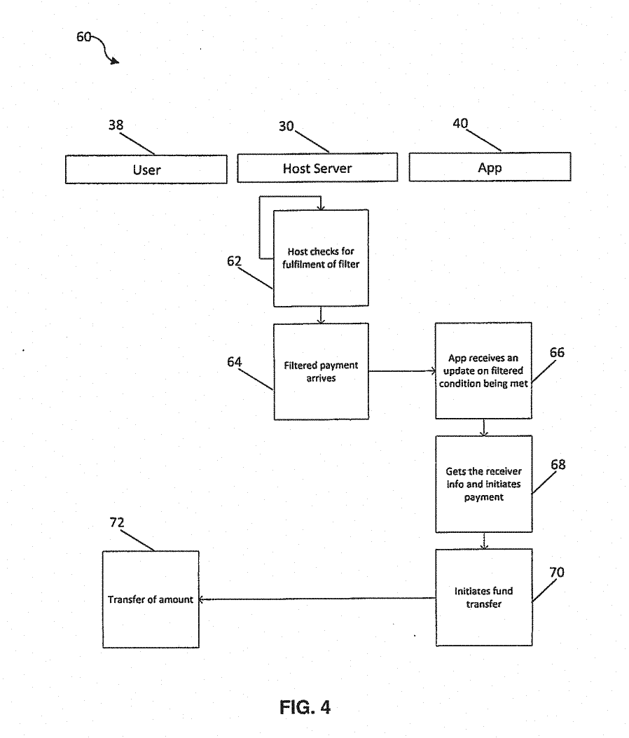

FIG. 4 shows a method 60 for initiation of a scheduled payment in accordance with an embodiment of the disclosure. In this case, the set-up procedure 36 has already been performed by the user 38 and the host server 30 is aware of the specified criteria for the payment.

In step 62, the host server 30 checks whether the specified criteria (i.e., filters) have been fulfilled. This may comprise the host server 30 communicating over the communication network 26 to interrogate the user's bank server 28 to determine whether, for example, a payment has been received from the specified name or with the specified keyword in the description. In an alternative embodiment, the function of the host server 30 may be incorporated into the user's bank server 28 such that the user's bank account can be checked directly for fulfilment of the specified criteria. It will be understood that the host server 30 may check the above at the frequency determined in previous step 46. If the specified criteria are not met, no action is taken until the host server 30 is next scheduled to check for the payment.

If the specified criteria have been met and the funds are received in the user's account, the user's bank server 28 will notify the host server 30 in step 64 and will send a notification to the App 40 in step 66. The App 40 will then, in step 68, retrieve the instructions for the payment to be made from a memory (which may be a local memory on the user device or a remote memory on the host server). In step 70, the App 40 will initiate the payment (i.e., fund transfer) on the basis of the instructions. Note, in some embodiments, the App 40 may seek confirmation from the user that the scheduled payment is to proceed prior to step 70. Furthermore, the initiation of the payment may be by instruction to the host server 30 or user bank account to proceed with the payment to the nominated recipient. In step, 72 the payment is made and the user's bank account updated. The App 40 may also confirm to the user that the payment has been successful.

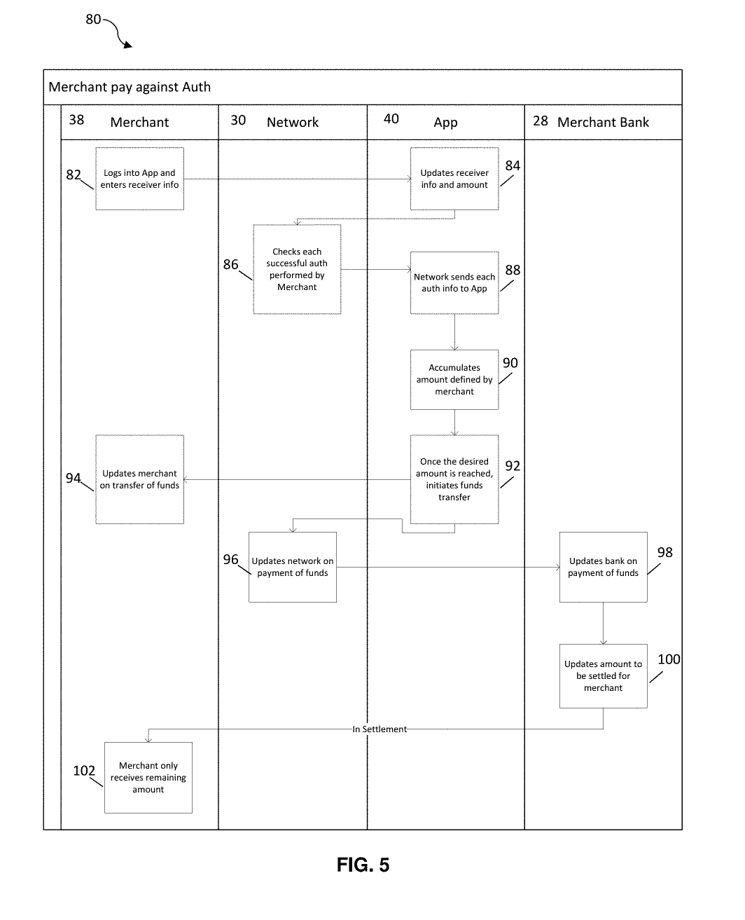

FIG. 5 shows a method 80 for a merchant 38 to make a scheduled payment using authorized funds in accordance with an embodiment of the disclosure.

In step 82 the merchant logs into the App 40 using previously established login credentials (e.g., username and password) and enters the instructions for the action to be taken (which, in this case is a payment to be made to a recipient but in other embodiments may be a notification to be sent to the user) when the required authorized funds are received. In step 84, the App 40 stores the receiver information (i.e., account number) and amount for payment. In step 86, the App 40 communicates over the communication network 26 with the host server 30 to monitor each successful authorization performed by the merchant (e.g., when a customer makes a cashless transaction for goods or services). This may comprise the host server 30 communicating with the merchant's payment card server to check when authorizations are received.

In step 88, the host server 30 communicates details of each successful authorization to the App 40 and in step 90 the App accumulates all of the authorizations received (and not yet spent). In some embodiments, only a portion of the authorized funds may be made available for payments and therefore the App 40 may calculate the accumulated portions of the authorized funds. In step 92, once the amount for payment has been reached, the App 40 will initiate the payment (i.e., fund transfer) or notification in accordance with the stored instructions. In step 94, the App 40 confirms to the merchant that the payment has been initiated and in step 96, the App 40 notifies the host server 30 that the payment is to be made and the host server 30, in turn, updates the merchant's bank server 28 that the payment is to be made using the authorized funds, as shown in step 98. The merchant's bank server 28 then transfers the amount to the recipient using known methods.

In step 100, the merchant's bank server 28 deducts the amount paid to the recipient (plus a fee for the service if, applicable) from the authorized funds to be settled for the merchant. Thus, in step 102, the merchant receives only the remaining amount (i.e., minus the amount paid to the recipient) upon settlement of the authorized funds.

It will therefore be apparent that embodiments of the disclosure, provide a method and system for scheduling payments either on the basis of funds received or funds authorized for receipt such that there is much less delay in these funds being used for future payments. This may not only help individuals to more efficiently manage their incoming and outgoing payments but will also benefit merchants and their suppliers by allowing authorized funds to be spent before the money is actually received.

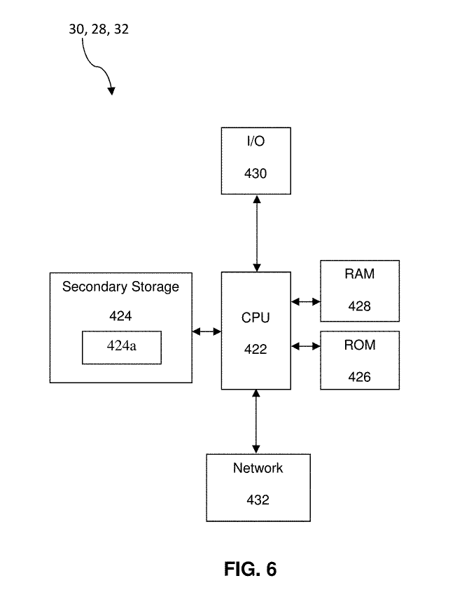

FIG. 6 is a block diagram showing a technical architecture of the host server (or payment card server) 30. The user's bank server 28 or receiver's bank server 32 may also have this technical architecture.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 7 is a block diagram showing a technical architecture of the user device 24 and recipient device 34.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a. In the case of the customer mobile device 28, a camera 330b and a geolocation module 330c may also be provided. The UI 330a may comprise a touch screen, keyboard, keypad or other known input device. The camera 330b allows a user to capture images and save the captured images in electronic form. The geolocation module 330c is operable to determine the geolocation of the communication device using signals from, for example, global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiments can be made in accordance with the appended claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computerized method for scheduling payments, the method comprising:
a) storing, in a memory, instructions for an action to be taken when at least one specified criterion is fulfilled, the specified criterion relating to anticipated funds to be received and/or anticipated funds authorized for receipt;
b) receiving, by a processor, details of funds received and/or funds authorized for receipt;
c) checking, by the processor, whether the specified criterion is fulfilled;
d) repeating steps b) and c) until the specified criterion is fulfilled; and
e) upon fulfillment of the specified criterion, actioning the instructions stored in the memory.

2. The method according to claim 1, wherein the instructions relate to a scheduled payment to be made when the specified criterion is fulfilled, such that, upon fulfilment, the payment is initiated.

3. The method according to claim 1, wherein the instructions relate to providing a notification to a user of the funds received and/or funds authorized for receipt such that the user can choose whether to make a payment as soon as the funds/authorization is received.

4. The method according to claim 1, wherein the specified criterion comprises one of more of a name, entity, account number, amount, date or predetermined type of payment.

5. The method according to claim 4 wherein the amount comprises an individual amount received or authorized; an accumulated amount received or authorized; or a portion of an amount received or authorized.

6. The method according to claim 1, wherein the specified criterion comprises a specified amount or an amount equal to or greater than a specified amount.

7. The method according to claim 2, wherein the instructions for payment are for one time only payments or regular payments;
wherein the instructions are used to schedule bill payments or to transfer funds to another account; and/or
wherein the instructions for payment are conditional on the funds received.

8-9. (canceled)

10. The method according to claim 2, wherein upon fulfillment of the specified criterion, an alert is sent to a user device for information and/or confirmation before the payment is initiated according to the instructions.

11. The method according to claim 1, wherein the authorized funds are only permitted to be spent on pre-defined goods or services or with pre-defined parties; and
wherein the authorized funds are not permitted to be withdrawn as cash and instead are only permitted to be transferred to a pre-defined receiver.

12. (canceled)

13. The method according to claim 1, wherein only a portion of the authorized funds is made available for payments.

14. The method according to claim 1, wherein a fee is deducted from the authorized funds for payments making use of the authorized funds.

15. The method according to claim 1, further comprising a set-up procedure wherein a user or merchant provides the instructions for the payment to be made and the at least one specified criterion.

16. (canceled)

17. A system comprising a processor for scheduling payments, the processor configured to:
a) store, in a memory, instructions for an action to be taken when at least one specified criterion is fulfilled, the specified criterion relating to anticipated funds to be received and/or anticipated funds authorized for receipt;
b) receive details of funds received and/or funds authorized for receipt;
c) check whether the specified criterion is fulfilled;
d) repeat steps b) and c) until the specified criterion is fulfilled; and
e) upon fulfillment of the specified criterion, action the instructions stored in the memory.

18. The system according to claim 17, wherein the processor is located in a user device, host server, payment card server or user's bank server.

19. The system according to claim 17, wherein the processor is further configured to:
receive the instructions and/or specified criterion from a user application operating on a user device; and
communicate with the user application to inform the user of receipt of funds or authorized funds.

20. The system according to claim 19, wherein the processor is configured to receive the details of the funds received and/or funds authorized for receipt from a user's bank server or payment card server.

21. (canceled)

22. The system according to claim 19, wherein the processor is further configured to check whether the user intends to proceed with a payment when the specified criterion is met.

23. The system according to claim 19, wherein the processor is further configured to:
communicate to the user the total authorized funds received and/or a predefined portion of the authorized funds received that is available for payments; and
calculate an accumulated total of the predefined portions of multiple authorized funds and to generate an alert to the user when a target amount is reached;
wherein a payment is scheduled to be made when the target amount is reached.

24-25. (canceled)

26. The system according to claim 17, wherein the processor is further configured, when authorized funds are used, to set a flag on a user account to deduct a portion of the authorized funds used for the payment from the total authorized funds when the total authorized funds are received in the user account.

27. A non-transitory computer-readable storage medium having stored thereon program instructions that, when executed by at least one processor, cause the at least one processor to:
a) store, in a memory, instructions for an action to be taken when at least one specified criterion is fulfilled, the specified criterion relating to anticipated funds to be received and/or anticipated funds authorized for receipt;
b) receive details of funds received and/or funds authorized for receipt;
c) check whether the specified criterion is fulfilled;
d) repeat steps b) and c) until the specified criterion is fulfilled; and
e) upon fulfillment of the specified criterion, action the instructions stored in the memory.
